(19) United States
(12) Patent Application Publication
(10) Pub. No.: US 2025/0330438 A1
(43) Pub. Date: Oct. 23, 2025

(54) METHOD AND DEVICE FOR DISPLAYING MESSAGE

(71) Applicant: KAKAO CORP., Jeju-si (KR)

(72) Inventors: Hye Jung ROH, Seongnam-si (KR); Min Hee KIM, Seongnam-si (KR); Yoon Hwan OH, Seongnam-si (KR); Hyo Jin KIM, Seongnam-si (KR); Sung Mok JI, Seongnam-si (KR); Ye Ram HAN, Seongnam-si (KR)

(73) Assignee: KAKAO CORP., Jeju-si (KR)

(21) Appl. No.: 19/183,575

(22) Filed: Apr. 18, 2025

(30) Foreign Application Priority Data
Apr. 22, 2024 (KR) 10-2024-0053553

(51) Int. Cl. H04L 51/212; G06F 16/34; H04L 9/40; H04L 51/04

(52) U.S. Cl. CPC H04L 51/212; G06F 16/345; H04L 51/04; H04L 63/08

(57) ABSTRACT

A server may include one or more processors configured to receive, from a sender terminal associated with a sender account, a message transmission request requesting delivery of a message to a user account via a chatroom. The one or more processors determine a type of the message as one of a plurality of types, including an advertisement type and an information type, based on the message transmission request. Upon determining that the message is of the information type, the one or more processors transmit the message along with the information indicating a restriction on displaying at least a portion of content provided in the chatroom to a user terminal of the user account. This enables the user terminal to dynamically control the visibility of non-essential or promotional content, such as advertisements or service buttons, thereby enhancing the user experience by improving focus on critical or sensitive information.

### CROSS-REFERENCE TO RELATED APPLICATION

This application claims the benefit of Korean Patent Application No. 10-2024-0053553 filed on Apr. 22, 2024, in the Korean Intellectual Property Office, the entire disclosure of which is incorporated herein by reference for all purposes.

### BACKGROUND

### Technical Field

Hereinafter, technology for providing a message in an instant messaging service (IMS) is disclosed.

### Description of the Related Art

With the recent advancement of mobile smart devices, the use of online platform services for interaction with other users through networks has been increasing. Representative examples of online platform services for interaction with other users include social networking services (SNS), which are online platforms to help create and strengthen social relationships through communication, information sharing, and expanding connections between users, and instant messaging services (IMS), which are online platforms for real-time content communication between two or more users. As user interaction through such mobile devices increases, online platform services support functions to provide chat services for daily conversations with other users as well as various services based on communication between a plurality of users.

### BRIEF SUMMARY

According to an aspect, there is provided a method of displaying a message, performed by a user terminal, the method including receiving, from a server, information about a message through a chatroom of a user account and a sender account, checking a type of the message using the information about the message, wherein the type of the message is one of a plurality of types including an advertisement type and an information type, and displaying the message through a chatroom page corresponding to the chatroom and restricting display of at least a portion of content provided in the chatroom, based on the type of the message being an information type.

The displaying of the message and restricting of the display of at least a portion of the content may include restricting display of advertising content provided in the chatroom or display of a button to enter a service page provided by the sender account in the chatroom.

The checking of the type of the message may include checking a subtype of the message based on the type of the message being an information type, wherein the subtype of the message is one of a plurality of subtypes including a general information type and an important information type, and the displaying of the message and restricting of the display of at least a portion of the content may include displaying, based on the subtype of the message being an important information type, a graphical representation that represents the important information type along with the message.

The method may further include transmitting, to the server, a summary request for a plurality of messages received in the chatroom, receiving, from the server based on the plurality of messages including one or more information-type messages and one or more advertisement-type message, information for displaying first summarized texts individually corresponding to the one or more information-type messages and a second summarized text that summarizes the one or more advertisement-type message, and displaying the first summarized texts and the second summarized text.

The checking of the type of the message may include checking the type of a last message among messages transmitted through the chatroom, and the displaying of the message and restricting of the display of at least a portion of the content may include restricting display of at least a portion of the content based on the type of the last message being an information type.

The checking of the type of the message may include checking types of a plurality of unread messages transmitted through the chatroom.

The displaying of the message and restricting of the display of at least a portion of the content may include restricting display of at least a portion of the content provided in the chatroom, based on a type of at least one of the plurality of unread messages being an information type, and the method may include displaying the content provided in the chatroom, based on types of all of the plurality of unread messages being an advertisement type.

The checking of the type of the message may include checking a type of a focused message among a plurality of messages transmitted through the chatroom, and the displaying of the message and restricting of the display of at least a portion of the content may include restricting display of at least a portion of the content provided in the chatroom, based on the type of the focused message being an information type.

The method may further include detecting a user input that changes a focused message among a plurality of messages transmitted through the chatroom from a first message to a second message, when displaying the chatroom page, displaying at least a portion of the content in response to the user input, based on a type of the first message being an information type and a type of the second message being an advertisement type, and restricting at least a portion of the content in response to the user input, based on the type of the first message being an advertisement type and the type of the second message being an information type.

The method may further include detecting a user input that changes a focused message among a plurality of messages transmitted through the chatroom from a first message to a second message, when displaying the chatroom page, and restricting display of at least a portion of the content in response to the user input, based on the second message being a message transmitted before the first message.

According to an aspect, there is provided a method of providing a message, performed by a server, the method including receiving, from a sender terminal of a sender account, a message transmission request that requests delivery of a message to a user account through a chatroom, determining a type of the message to be one of a plurality of types including an advertisement type and an information type, based on the message transmission request, and transmitting information indicating restriction on display of at least a portion of content provided in the chatroom along with the message to a user terminal of the user account, based on a determination that the type of the message is an information type.

The transmitting of the information along with the message may include transmitting information indicating restriction on display of advertising content provided in the chatroom or display of a button to enter a service page provided by the sender account in the chatroom to the user terminal.

The determining of the type of the message may include determining a subtype of the message to be one of a plurality of subtypes including a general information type and an important information type, based on a determination that the type of the message is an information type, and the transmitting of the information may include transmitting, to the user terminal based on a determination that the subtype of the message is an important information type, information indicating display of a graphical representation that represents the important information type along with the message.

The receiving of the message transmission request may include receiving, from the sender terminal, the message transmission request including authentication information of the sender account, and the transmitting of the information may include authenticating the sender account by comparing the authentication information of the sender account with registered authentication information that is registered for the sender account, based on a determination that the subtype of the message is an important information type, and transmitting the information and the message to the user terminal, based on successful authentication of the sender account.

The authenticating of the sender account may include determining whether the sender account has permission to transmit an important-information-type message, based on a determination that the subtype of the message is an important information type, and authenticating the sender account, based on a determination that the sender account has permission to transmit an important-information-type message.

The method may further include receiving, from the user terminal, a summary request for a plurality of messages in the chatroom, generating, for each information-type message based on the plurality of messages including one or more information-type messages, a first summarized text that summarizes the information-type message, generating, based on the plurality of messages including one or more advertisement-type messages, a second summarized text that summarizes the one or more advertisement-type messages, and transmitting, to the user terminal, information for displaying first summarized texts individually corresponding to the one or more information-type messages and the second summarized text.

According to an aspect, there is provided a user terminal including a processor configured to receive, from a server, information about a message through a chatroom of a user account and a sender account, check a type of the message using the information about the message, wherein the type of the message is one of a plurality of types including an advertisement type and an information type, and display the message through a chatroom page corresponding to the chatroom and restrict display of at least a portion of content provided in the chatroom, based on the type of the message being an information type.

According to an aspect, there is provided a server including a processor configured to receive, from a sender terminal of a sender account, a message transmission request that requests delivery of a message to a user account through a chatroom, determine a type of the message to be one of a plurality of types including an advertisement type and an information type, based on the message transmission request, and transmit information indicating restriction on display of at least a portion of content provided in the chatroom along with the message to a user terminal of the user account, based on a determination that the type of the message is an information type.

The various embodiments of the user terminal dynamically controls the visibility of non-essential or promotional content, such as advertisements or service buttons, thereby enhancing the user experience by improving focus on critical or sensitive information. The various embodiments of the present disclosure improve content relevance and attention management within messaging interfaces, particularly in chat environments with mixed message types.

Further aspect of the present disclosure includes a technical solution to a problem that arises specifically in the context of instant messaging systems and their user interfaces. Conventional chat platforms present all incoming messages uniformly, regardless of content type, which results in diminished usability when high-priority or sensitive information is intermixed with less relevant promotional content. This disclosure addresses that technical challenge by introducing a message-type-aware rendering mechanism in which a user terminal, based on metadata received from a server, dynamically controls the visibility of associated user interface elements such as advertising banners or service page buttons. The content display is modified based on whether the message is classified as an information type (e.g., important or general) or an advertisement type, allowing the user interface to adapt in real time to the semantics of the incoming message.

Unlike abstract methods of organizing human activity or mere presentation of information, the disclosed system leverages specific computing components—including processors, communicators, display modules, and memory—to execute these message-type-aware operations. For instance, when a message of the information type is received, the user terminal may reduce resource consumption by refraining from rendering extraneous content until explicitly requested by the user, thereby improving memory efficiency and user focus.

Moreover, the disclosure includes a mechanism for generating summarized versions of multiple messages, which may be implemented on the server using machine learning or rule-based models, thereby reducing the volume of network traffic and enhancing client-side performance. These improvements to computational resource usage, network efficiency, and rendering behavior demonstrate that the disclosure is rooted in computer technology and provides tangible enhancements to the functioning of messaging systems.

Furthermore, the dynamic content suppression and summarization techniques described herein are not capable of being performed purely in the human mind and are not directed to mere data classification. Rather, they require cooperation between backend infrastructure (e.g., a server determining message types and generating summaries) and frontend components (e.g., user terminals controlling content display state). The metadata-driven logic, selective rendering, and contextual user input handling described throughout this disclosure are implemented through specifically configured computing systems and result in improvements in latency, user experience, and platform scalability. As such, the various embodiments of the disclosure offers a concrete and technical solution to a problem that is deeply rooted in the functioning of modern messaging systems.

Additional aspects of embodiments will be set forth in part in the description which follows and, in part, will be apparent from the description, or may be learned by practice of the disclosure.

### BRIEF DESCRIPTION OF THE SEVERAL VIEWS OF THE DRAWINGS

These and/or other aspects, features, and advantages of the disclosure will become apparent and more readily appreciated from the following description of embodiments, taken in conjunction with the accompanying drawings of which:

FIG. 1 illustrates an example of a message transmission system according to various embodiments;

FIG. 2 is a flowchart illustrating an example of a message providing method performed by a server according to various embodiments;

FIG. 3 is a flowchart illustrating an example of a message displaying method performed by a user terminal according to various embodiments;

FIG. 4A illustrates an example of an interface for a user terminal to display content provided through a chatroom according to various embodiments;

FIG. 4b illustrates an example of an interface for a user terminal to restrict the display of at least a portion of content provided through a chatroom according to various embodiments;

FIG. 5 is a diagram illustrating an example of an operation of providing a graphical representation that represents the subtype of a message by a message transmission system according to various embodiments;

FIG. 6 is a diagram illustrating an example of an operation of verifying a sender account of a message transmission request by a server according to various embodiments;

FIG. 7 is a diagram illustrating an example of an operation of providing a summary of a message by a message transmission system according to various embodiments;

FIG. 8 is a diagram illustrating an example of an operation of controlling the display of at least a portion of content by a user terminal according to various embodiments; and

FIG. 9 illustrates an example of a chatroom list screen of a user terminal according to various embodiments.

### DETAILED DESCRIPTION

The following detailed structural or functional description is provided as an example only and various alterations and modifications may be made to the examples. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if one component is described as being “connected,” “coupled,” or “joined” to another component, a third component may be “connected,” “coupled,” and “joined” between the first and second components, although the first component may be directly connected, coupled, or joined to the second component.

As used herein, the singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, the embodiments will be described in detail with reference to the accompanying drawings. When describing the examples with reference to the accompanying drawings, like reference numerals refer to like elements and any repeated description related thereto will be omitted.

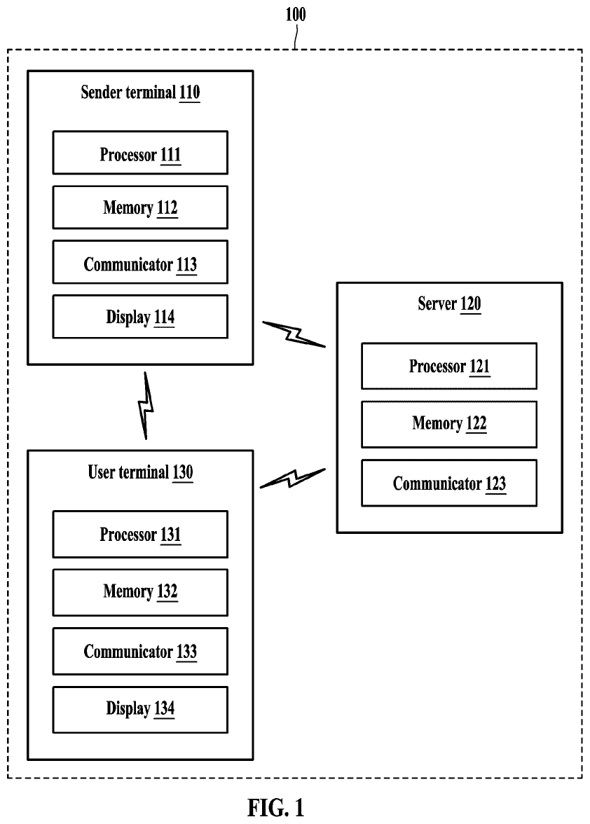

FIG. 1 illustrates an example of a message transmission system according to various embodiments.

A message transmission system 100 according to an embodiment may include a sender terminal 110, a server 120, and a user terminal 130.

The sender terminal 110 and/or the user terminal 130 may be one of electronic devices including a computer, a portable computer, a wireless phone, a mobile phone, a smart phone, a personal digital assistant (PDA), a web tablet, and the like, and may include any device on which a service application associated with the server 120 can be installed and run. Here, the sender terminal 110 and/or the user terminal 130 may perform overall service operations such as service screen configuration, data input, data transmission and reception, and data storage under the control of an application. For example, the sender terminal 110 and/or the user terminal 130 may access the server 120 through the application. For example, the sender terminal 110 and/or the user terminal 130 may use an instant messaging service (IMS), an electronic document service, or a notification message service provided by the server 120.

The server 120 may provide a service to the sender terminal 110 and/or the user terminal 130. For example, the server 120 may provide an IMS or a social networking service (SNS). The server 120 may provide an electronic document service (e.g., an electronic notification service). According to an embodiment, the server 120 may include an electronic document server (not shown) and a notification message server (not shown). The electronic document server may provide a service for sending and/or receiving an electronic document to the sender terminal 110 and/or the user terminal 130. The notification message server may provide a service for sending a notification message corresponding to the sending of an electronic document to the sender terminal 110 and/or the user terminal 130. The electronic document service may be a service for sending an electronic document from a sender (e.g., a public institution) to a recipient (e.g., an individual).

The electronic document service according to an embodiment may provide a service that supports requesting identity verification for a recipient to view an electronic document after the electronic document has been sent, allowing the recipient to view the electronic document in response to successful identity verification, monitoring whether the electronic document has been viewed, providing the sender with information regarding whether the electronic document has been viewed, and/or obtaining a response regarding agreement after the recipient has viewed the electronic document.

The notification message service may be a service for transmitting a notification message from a sender account to a user account (e.g., a recipient account). The sender account may be a corporate account. The notification message may be sent to the recipient account independently of whether the recipient account has registered the sender account as a friend. The notification message may be classified as an information-type message that provides information to the recipient account. In various embodiments of the present disclosure, a notification message may also be expressed as a “notification talk.”

According to various embodiments of the present disclosure, a sender may transmit an electronic document to a recipient using a notification message. The notification message may contain information about the electronic document. For example, the information about the electronic document may include information about the sender of the electronic document (e.g., name, contact information), information about the recipient (e.g., name), a viewing period, and/or a button for viewing the electronic document. The button for viewing the electronic document may be a button for requesting the display of an area corresponding to the electronic document.

For example, the sender may be a public institution and/or a corporation, and the recipient may be an individual. However, the sender and the receiver are not limited to the examples described above, and each of the sender and the receiver may be an individual, and an electronic document (e.g., a contract) corresponding to a contract between the sender and the receiver may be transmitted. In various embodiments of the present disclosure, a “user” may primarily be a recipient of an electronic document.

The user account and/or the sender account are created upon subscription to a service provided by the server 120, and the server 120 may serve as a service platform that provides services, such as an SNS, an IMS, and the like, to the user account and/or the sender account that was used to subscribe to the services. A user account and/or a sender account described herein primarily refer to accounts that have signed up for an IMS. Since the sender terminal 110 subscribes to a service using the sender account, the sender account included in the following embodiments may be construed as substantially corresponding to the sender terminal 110. Similarly, the user account may be construed as corresponding to the user terminal 130.

According to an embodiment, the sender terminal 110 may include a processor 111, a memory 112, a communicator 113, and a display 114.

The processor 111 may transmit a message transmission request requesting transmission of a message through a chatroom to the server 120. The processor 111 may receive information regarding whether the message has been viewed from the server 120. The processor 111 may temporarily or permanently store, in the memory 112, data required for transmitting the message transmission request and/or receiving information regarding whether the message has been viewed.

The memory 112 may store the message transmission request and/or the information regarding whether the message has been viewed. The memory 112 may store instructions for transmitting the message transmission request and/or receiving information regarding whether the message has been viewed.

The communicator 113 may transmit at least one of the message transmission request or the information regarding whether the message has been viewed. The communicator 113 may establish a wired communication channel and/or a wireless communication channel with an external device (e.g., another electronic device and a server), and may establish communication via cellular communication, short-range wireless communication, local area network (LAN) communication, Bluetooth™, wireless-fidelity (Wi-Fi), infrared data association (IrDA), or a long-range communication network such as a legacy cellular network, fourth-generation (4G) and/or fifth-generation (5G) network, next-generation communication, the Internet, or a computer network (e.g., LAN or wide area network (WAN)).

The display 114 may visualize information about the message transmission request. For example, the display 114 may be a touch display in which a touch sensing module and a display module are integrally implemented.

According to an embodiment, the server 120 may include a processor 121, a memory 122, and a communicator 123.

The processor 121 may receive the message transmission request from the sender terminal 110. The processor 121 may determine (e.g., check) the type of the message. The processor 121 may transmit information indicating a restriction on the display of at least a portion of the content along with the message. The processor 121 may also temporarily or permanently store, in the memory 122, data required for receiving the message transmission request, determining the type of the message, and/or transmitting the information indicating the restriction on the display of at least a portion of the content.

The memory 122 may store the message transmission request, the type of the message, and/or the information indicating the restriction on the display of at least a portion of the content. The memory 122 may store instructions for receiving the message transmission request, determining the type of the message, and/or transmitting the information indicating the restriction on the display of at least a portion of the content.

The communicator 123 may transmit at least one of the message or the message transmission request, the type of the message, and/or the information indicating the restriction on the display of at least a portion of the content. The communicator 123 may establish a wired communication channel and/or a wireless communication channel with an external device (e.g., the sender terminal 110, another electronic device, etc.), and may establish communication via cellular communication, short-range wireless communication, local area network (LAN) communication, Bluetooth™, wireless-fidelity (Wi-Fi), infrared data association (IrDA), or a long-range communication network such as a legacy cellular network, fourth-generation (4G) and/or fifth-generation (5G) network, next-generation communication, the Internet, or a computer network (e.g., LAN or wide area network (WAN)).

According to an embodiment, the user terminal 130 may include a processor 131, a memory 132, a communicator 133, and a display 134.

The processor 131 may receive information about the message from the server 120. The processor 131 may determine (e.g., check) the type of the message. The processor 131 may display the message and restrict the display of at least a portion of the content provided in the chatroom. The processor 131 may also temporarily or permanently store, in the memory 132, information indicating reception of the information about the message, determination of the type of the message, display of the message, and/or restriction on the display of at least a portion of the content.

The memory 132 may store the information about the message, the type of the message, and/or information indicating the restriction on the display of at least a portion of the content. The memory 132 may store instructions for receiving the information about the message, determining the type of the message, displaying the message, and/or restricting the display of at least a portion of the content.

The communicator 133 may transmit at least one of the information about the message, the type of the message, or the information indicating the restriction on the display of at least a portion of the content. The communicator 133 may establish a wired communication channel and/or a wireless communication channel with an external device (e.g., the sender terminal 110, the server 120, or another electronic device), and may establish communication via cellular communication, short-range wireless communication, local area network (LAN) communication, Bluetooth™, wireless-fidelity (Wi-Fi), infrared data association (IrDA), or a long-range communication network such as a legacy cellular network, fourth-generation (4G) and/or fifth-generation (5G) network, next-generation communication, the Internet, or a computer network (e.g., LAN or wide area network (WAN)).

The display 134 may visualize the message, and/or at least a portion of the content provided in the chatroom. For example, the display 134 may be a touch display in which a touch sensing module and a display module are integrally implemented.

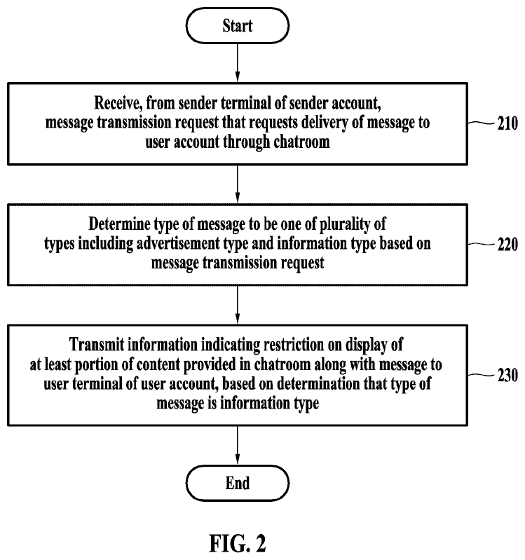

FIG. 2 is a flowchart illustrating an example of a message providing method performed by a server according to various embodiments.

A server (e.g., the server 120 of FIG. 1) according to an embodiment may transmit a message to a user terminal (e.g., the user terminal 130 of FIG. 1) based on a message transmission request received from a sender terminal (e.g., the sender terminal 110 of FIG. 1). The user terminal may also be expressed as a recipient terminal, as it is the user terminal of the recipient of the message.

In operation 210, the server may receive, from a sender terminal of a sender account, a message transmission request requesting delivery of a message to a user account through a chatroom.

The sender account may be an account that was used to subscribe to an electronic document service provided by the server and registered to send an electronic document. The sender account may be an account that has succeeded in verifying the identity of a sender of the sender account (e.g., identity verification) and registered the authentication information, to subscribe to the electronic document service.

According to an embodiment, the electronic document service may provide the sender with a plurality of options for sending an electronic document. The options may be additional actions to be performed on an electronic document after the electronic document has been sent. For example, the options may include an action of allowing viewing of an electronic document if a predetermined condition is met, an action of determining whether the electronic document has been viewed by a recipient, or an action of requesting and/or obtaining a consent signature after viewing the electronic document. The consent signature may be the signature of the recipient on the electronic document. With the performance of the content signature, it may be determined that the consent signature for the electronic document has been completed if the recipient is requested to perform identity verification and the identity verification is successful.

For example, the first option may include an action of requesting the recipient to perform identity verification to view the electronic document and allowing viewing of the electronic document if the recipient succeeds in identity verification. The second option may include an action of determining whether the recipient has viewed the electronic document and replying to the sender with information regarding whether the recipient has viewed the electronic document. The third option may include an action of requesting a consent signature after the recipient views the electronic document and replying to the sender with information about the consent signature.

The sender terminal may generate a message transmission request including the electronic document by specifying each option or a plurality of options and/or transmit the message transmission request to the server. According to an embodiment, the server may provide (e.g., sell) an electronic document sending product having each option or a plurality of options to the sender (or the sender account) through the provision of the electronic document service. The sender account obtaining (e.g., purchasing) the electronic document sending product may request the server or the user terminal to perform an action corresponding to an option included in the electronic document sending product by sending the electronic document to the recipient through the electronic document sending product.

The message transmission request may include information about a message, information about the sender of the message, information about the recipient of the message, and/or information about the electronic document included in the message.

In operation 220, the server may determine the type of the message to be one of a plurality of types including an advertisement type and an information type based on the message transmission request.

The type of the message may be the category of the message classified based on the substance of the message. For example, the type of the message may be determined (e.g., checked) to be one of the plurality of types. The plurality of types may include an information type and an advertisement type. In various embodiments of the present disclosure, an information-type message may be expressed as an information-based message, and an advertisement-type message may be expressed as an advertisement-based message.

The message transmission request may include a value indicating the type of the message. For example, the message transmission request may include metadata of the message. The metadata of the message may include a flag indicating the type of the message (e.g., a type flag). The flag may have one of a plurality of values, and the plurality of values may individually correspond to the plurality of types. The type flag of the message having a predetermined value may indicate that the type of the message is a type corresponding to the predetermined value. The sender terminal may determine the value of the type flag and transmit a message transmission request including the determined value of the type flag to the server. The server may determine (e.g., check) the type of the message based on the value of the type flag included in the message transmission request. For example, the server may determine the type of the message to be the type corresponding to the predetermined value based on the type flag being the predetermined value.

In operation 230, the server may transmit information indicating a restriction on the display of at least a portion of content provided in the chatroom to the user terminal of the user account along with the message, based on a determination that the type of the message is an information type.

Here, the content may be content other than the message. The content may be content provided in the chatroom in which the recipient account and the sender account participate. For example, the content may include advertising content provided in the chatroom. For example, the content may include a button to enter a service page provided by the sender account within the chatroom.

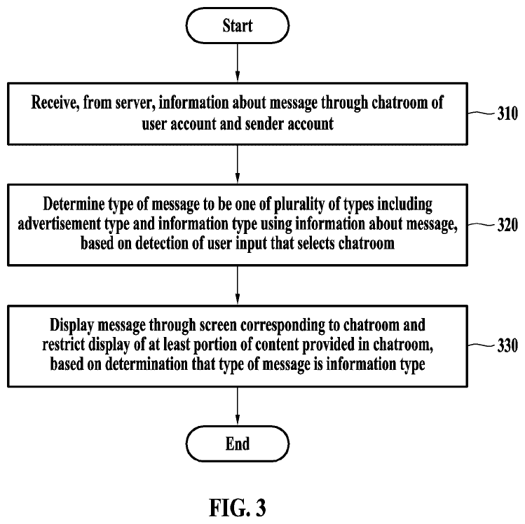

The server may transmit information indicating the restriction on the display of at least a portion of the content to the user terminal. The information indicating the restriction on the display of at least a portion of the content may, for example, include metadata of the message. The server may transmit a type flag having a value corresponding to an information type along with the message to the user terminal. As described later with reference to FIG. 3, the user terminal may determine (e.g., check) the type of the message based on information received from the server and restrict the display of at least a portion of the content.

According to an embodiment, when the message to be sent to the recipient account is of an information type, the message may be provided with the accompanying content (e.g., advertising content unrelated to the message) restricted so that the recipient may focus on the message.

Although not explicitly shown in FIG. 2, the server may transmit information indicating the display of the content provided in the chatroom to the user terminal of the user account based on a determination that the type of the message is an advertisement type. The server may transmit a type flag having a value corresponding to an advertisement type along with the message to the user terminal. The user terminal may determine (e.g., check) the type of the message based on information received from the server and display the content (e.g., display the content without restriction).

FIG. 3 is a flowchart illustrating an example of a message displaying method performed by a user terminal according to various embodiments.

A user terminal (e.g., the user terminal 130 of FIG. 1) according to an embodiment may receive a message from a sender account delivered by a server (e.g., the server 120 of FIG. 1). The user terminal may receive a message through a chatroom in which a sender account and a user account participate.

In operation 310, the user terminal may receive, from the server, information about the message through the chatroom of the user account and the sender account. The information about the message, which is information for displaying the message, may include at least one of the message or metadata of the message. As described above with reference to FIG. 2, the metadata of the message may include a type flag indicating the type of the message. As described below, if the value of the type flag corresponds to an information type, the type flag may indicate a restriction on the display of at least a portion of the content.

In operation 320, the user terminal may detect an input of a user selecting the chatroom. The chatroom may be a chatroom in which the sender account and the user account participate. The input of the user may indicate entering a chatroom page corresponding to the chatroom. The chatroom page may include messages transmitted and received through the chatroom, and may further include content registered by the sender account. The content registered by the sender account may include, as described above with reference to FIG. 2, advertising content, and/or a button to enter a service page provided by the sender account.

The user terminal may determine (e.g., check) the type of the message based on information about the message (e.g., the type flag). For example, the user terminal may determine (e.g., check) the type of the message to be a type corresponding to a predetermined value based on the type flag being the predetermined value.

In operation 330, the user terminal may display the message through a screen corresponding to the chatroom and restrict the display of at least a portion of the content provided in the chatroom, based on a determination that the type of the message is an information type.

As described above with reference to FIG. 2, at least a portion of the content provided in the chatroom may include at least one of the advertising content provided in the chatroom or the button to enter the service page provided by the sender account in the chatroom.

The user terminal may restrict the display of at least a portion of the content provided in the chatroom. For example, the user terminal may display a button to display at least a portion of the content, instead of at least a portion of the content. The button to display at least a portion of the content may be displayed in a smaller size than at least a portion of the content. The user terminal may display at least a portion of the content instead of the button, in response to a user input selecting the button to display at least a portion of the content.

In various embodiments of the present disclosure, displaying the button to display at least a portion of the content instead of at least a portion of the content may be expressed as displaying at least a portion of the content in a folded state. Displaying at least a portion of the content may be expressed as displaying at least a portion of the content in an unfolded state. The user terminal may control the display state of at least a portion of the content to be either the folded state or the unfolded state based on the type of the message. For example, if it is determined (e.g., checked) that the type of the message is an information type, the user terminal may display at least a portion of the content in the folded state.

Although not explicitly shown in FIG. 3, the user terminal may display the content provided in the chatroom along with the message through the screen corresponding to the chatroom, based on a determination that the type of the message is an advertisement type. For example, if it is determined (e.g., checked) that the type of the message is an advertisement type, the user terminal may display at least a portion of the content in the unfolded state.

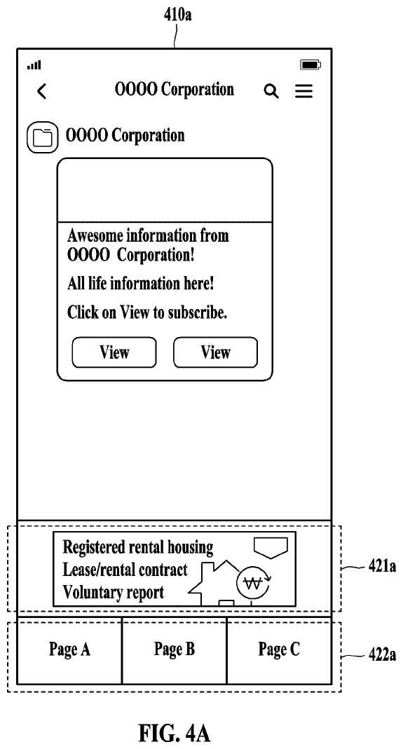

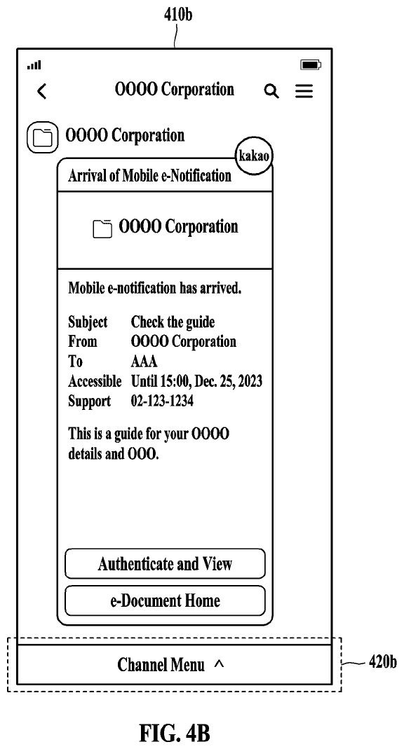

Displaying at least a portion of the content or restricting the display of at least a portion of the content by the user terminal is described in more detail below with reference to FIGS. 4A and 4B.

The user terminal according to an embodiment may control the display state of at least a portion of the content based on the type of a reference message at the time of detecting a user input selecting the chatroom, when one message or two or more messages are received through the chatroom.

For example, the user terminal may determine the last message to be the reference message. The user terminal may determine (e.g., check) the type of the last message among the messages transmitted through the selected chatroom. The user terminal may determine (e.g., check) the type of the last message based on metadata (e.g., a type flag) of the last message. The user terminal may restrict the display of at least a portion of the content based on a determination that the type of the last message is an information type. The user terminal may display at least a portion of the content in a folded state based on the type of the last message being an information type. The user terminal may display the content together with the last message based on a determination that the type of the last message is an advertisement type. The user terminal may display at least a portion of the content in an unfolded state based on the type of the last message being an advertisement type.

For example, the user terminal may determine an unread message to be the reference message. The state of a message transmitted and received through the chatroom may be an unread state until a user input corresponding to the chatroom is detected after the user terminal receives the message, and may change from the unread state to a read state in response to the user input. The user input corresponding to the chatroom may include a user input that causes the user terminal to display a chatroom page by selecting the chatroom. However, embodiments are not limited thereto, the user input corresponding to the chatroom may include a user input that requests changing the state of the message in the chatroom from an unread state to a read state.

The user terminal may detect a user input selecting a chatroom having a plurality of unread messages. The user terminal may determine (e.g., check) the types of the plurality of unread messages transmitted through the selected chatroom. The user terminal may restrict the display of at least a portion of the content provided in the chatroom based on a determination that the type of at least one of the plurality of messages is an information type. The user terminal may display at least a portion of the content in a folded state based on the type of at least one of the plurality of messages being an information type. The user terminal may display the content provided in the chatroom based on a determination that the types of all of the plurality of messages are an advertisement type. The user terminal may display at least a portion of the content in an unfolded state based on the types of all of the plurality of messages being an advertisement type.

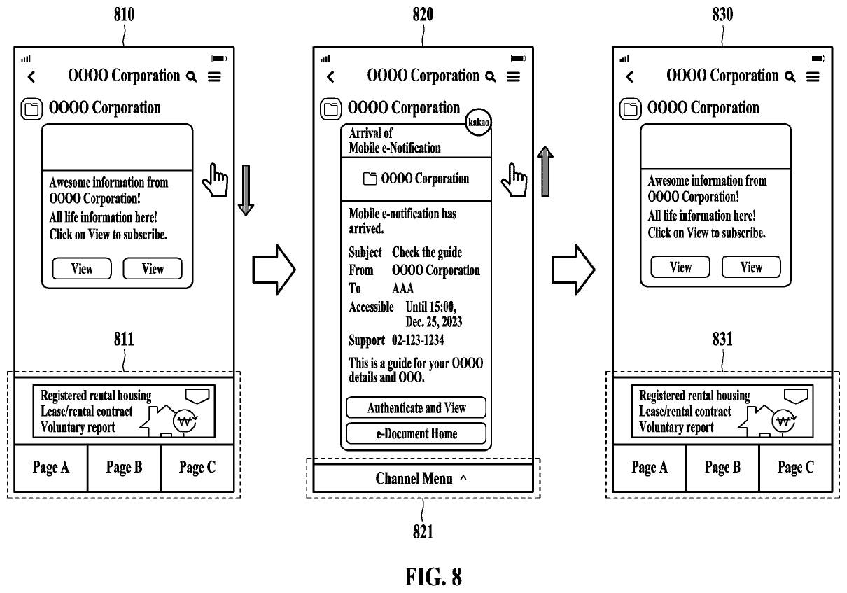

The user terminal according to various embodiments of the present disclosure is not limited to determining the reference message to be the last message or an unread message. For example, the user terminal may control the display of at least a portion of the content based on a focused message. Controlling the display of at least a portion of the content based on a focused message is described in more detail below with reference to FIG. 8.

FIG. 4A illustrates an example of an interface for a user terminal to display content provided through a chatroom according to various embodiments. FIG. 4b illustrates an example of an interface for a user terminal to restrict the display of at least a portion of content provided through a chatroom according to various embodiments.

In FIGS. 4A and 4B, a user terminal may display a chatroom page in response to a user input that selects a chatroom. FIG. 4A illustrates an example of an interface displayed by a user terminal when the type of a message is an advertisement type, and FIG. 4B illustrates an example of an interface displayed by a user terminal when the type of a message is an information type.

Referring to FIG. 4A, a user terminal may display a chatroom page 410a including at least a portion of content based on a determination that the type of a message is an advertisement type. At least a portion of the content may include advertising content 421a and a button 422a to enter a service page.

Referring to FIG. 4B, a user terminal may display a chatroom page 410b in which the display of at least a portion of content is restricted, based on a determination that the type of a message is an information type. The user terminal may display a button 420b to display at least a portion of the content, instead of at least a portion of the content (e.g., the advertising content 421a and the button 422a of FIG. 4A).

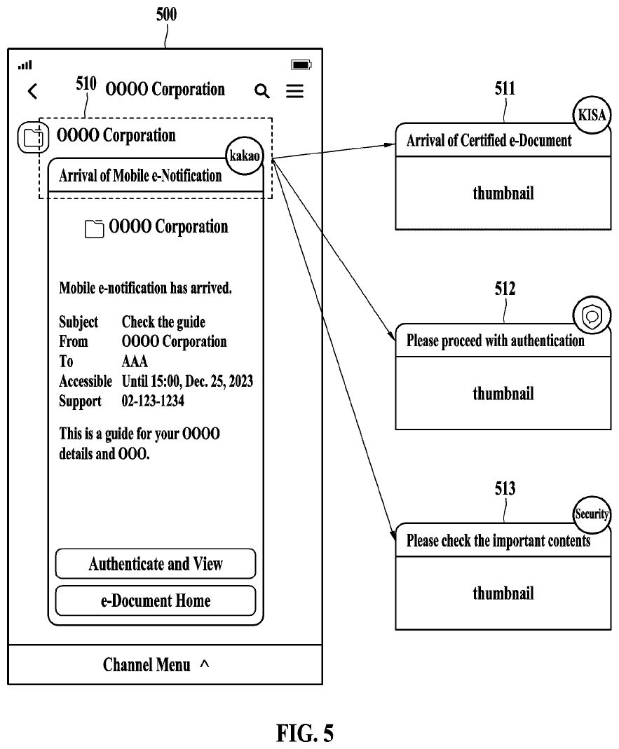

FIG. 5 is a diagram illustrating an example of an operation of providing a graphical representation that represents the subtype of a message by a message transmission system according to various embodiments.

When the type of a message is an information type, a message transmission system (e.g., the message transmission system 100 of FIG. 1) according to an embodiment may determine (e.g., check) the subtype of the message and further provide a graphical representation that represents the subtype. Subtypes of messages may be categories into which predetermined types of messages are classified based on more detailed criteria. For example, if the type of a message is an information type, the subtypes may include a general information type and an important information type. For example, if the type of a message is an information type, the subtypes may include a general information type, an electronic notification type, a certified electronic document type, an authentication request type, and/or an important information type (or a secure information type).

According to an embodiment, a sender terminal (e.g., the sender terminal 110 of FIG. 1) may generate a message provision request including information about the subtype of a message and/or transmit the message provision request to a server. The information about the subtype of a message may, for example, include a subtype flag of the message. The subtype flag may have one of a plurality of values, and the plurality of values may individually correspond to a plurality of subtypes. As described later, a server (e.g., the server 120 of FIG. 1) and/or a user terminal (e.g., the user terminal 130 of FIG. 1) may determine the subtype of the message based on the value of the subtype flag.

The server may receive the message provision request from the sender terminal. The server may determine the subtype of the message to be one of a plurality of subtypes including a general information type and an important information type, based on a determination that the type of the message is an information type.

The server may transmit information indicating display of a graphical representation that represents the subtype of the message to the user terminal, based on a determination of the subtype of the message. The information indicating the display of a graphical representation that represents the subtype of the message may include information about the subtype of the message (e.g., the subtype flag). For example, the server may transmit the information indicating the display of a graphical representation that represents an important information type along with the message to the user terminal, based on a determination that the subtype of the message is an important information type.

The user terminal may receive information about the subtype of the message from the server. The user terminal may determine (e.g., check) the subtype of the message to be one of a plurality of subtypes including a general information type and an important information type, based on a determination that the type of the message is an information type. The user terminal may display a graphical representation that represents the subtype of the message. For example, the user terminal may display a graphical representation that represents an important information type along with the message, based on a determination that the subtype of the message is an important information type.

Referring to FIG. 5, the user terminal may display a portion of a speech bubble corresponding to a message as a header 510 of the message on a chatroom page 500. For example, based on a determination that the type of the message is an information type, the user terminal may determine (e.g., check) the subtype of the message and display an upper partial area (e.g., the header 510) of the speech bubble of the message as a graphical representation that represents the subtype. A plurality of subtypes may individually correspond to a plurality of graphical representations. In FIG. 5, a first graphical representation of the header 510 may correspond to an electronic notification type, a second graphical representation 511 may correspond to a certified electronic document type, a third graphical representation 512 may correspond to an authentication request type, and a fourth graphical representation 513 may correspond to an important information type.

In various embodiments of the present disclosure, not all of the plurality of subtypes are limited to individually corresponding to the plurality of graphical representations, and some of the plurality of subtypes may correspond to graphical representations, and the rest of the plurality of subtypes may not correspond to graphical representations. The user terminal may not display a graphical representation if there is no graphical representation corresponding to the subtype of the message, and may display a corresponding graphical representation if there is a graphical representation corresponding to the subtype of the message.

When the type of a message is an information type, a message transmission system according to an embodiment may determine (e.g., check) the subtype of the message and display a graphical representation that represents the subtype of the message. The message transmission system may restrict (or omit) the determination of the subtype of the message and the display of the graphical representation when the type of the message is an advertisement type.

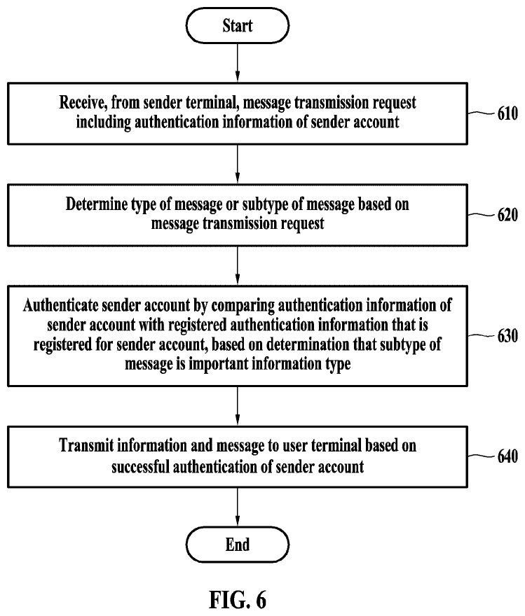

FIG. 6 is a diagram illustrating an example of an operation of verifying a sender account of a message transmission request by a server according to various embodiments.

A server (e.g., the server 120 of FIG. 1) according to an embodiment may perform verification on a sender account and/or a message when receiving a message transmission request from a sender terminal (e.g., the sender terminal 110 of FIG. 1), and transmit the message to a user terminal (e.g., the user terminal 130 of FIG. 1) if verification is successful.

In operation 610, the server may receive a message transmission request including authentication information of the sender account from the sender terminal.

In operation 620, the server may determine (e.g., check) the type of the message or the subtype of the message based on the message transmission request. As described above with reference to FIGS. 1 to 5, the server may determine (e.g., check) the type of the message to be an information type based on information about the message included in the message transmission request (e.g., a type flag). When the type of the message is determined to be an information type, the server may determine (e.g., check) the subtype of the message to be an important information type based on the information about the message (e.g., a subtype flag).

In operation 630, the server may authenticate the sender account by comparing authentication information of the sender account with registered authentication information that is registered for the sender account, based on a determination that the subtype of the message is an important information type. The registered authentication information may be information registered to an authentication service by the sender account.

Authenticating the sender account may be an operation of determining whether the sender and a service user are the same person based on whether the information input by the sender matches the pre-registered personal information of the service user.

According to an embodiment, the server may include an electronic document server and an authentication server. The electronic document server may transmit the authentication information of the sender account included in the message transmission request to the authentication server. The authentication server may perform authentication (e.g., verification) of the sender account by comparing the authentication information of the sender account with the registered authentication information. For example, the server may determine (e.g., check) that the authentication of the sender account is successful if the authentication information of the sender account is the same as the registered authentication information, and may determine that the authentication of the sender account has failed if the authentication information of the sender account is different from the registered authentication information.

However, the authentication of the sender account is not limited to being performed by the server. The registered authentication information may be stored in the user terminal (e.g., the sender terminal) of the sender account, and the authentication of the sender account may be performed by the sender terminal. For example, the sender terminal may obtain the authentication information of the sender account before transmitting the message transmission request to the server. The sender terminal may authenticate the sender account by comparing the authentication information of the sender account with the registered authentication information stored in the sender terminal. If the authentication of the sender account is successful, the sender terminal may transmit a message transmission request including information indicating the successful authentication of the sender account to the server. The server may confirm the successful authentication of the sender account based on the information indicating the successful authentication of the sender account, and process the message transmission request.

According to an embodiment, the server may determine, based on the subtype of the message, whether the sender account has permission to send a message of the determined subtype. The server may authenticate the sender account (e.g., compare authentication information of the sender account and registered authentication information) if it is determined that the sender account has permission to send a message of the subtype.

For example, the server may store subtypes of messages that can be sent by each sender account. The server may determine whether a message of the determined subtype can be sent by the sender account.

For example, the server may store, for each subtype, a list of sender accounts that are allowed to send messages of the corresponding subtype. The server may determine (e.g., check) the subtype of a message and search for a sender account from the list of sender accounts for the determined subtype, thereby determining whether the sender account is allowed to send a message of the determined subtype.

For example, the server may determine whether the sender account has permission to transmit a message of an important information type, based on a determination that the subtype of the message is an important information type. The server may authenticate the sender account based on a determination that the sender account has permission to send a message of an important information type.

According to an embodiment, the server may authenticate the sender account using one of a first authentication type and a second authentication type. The first authentication type may be a type that authenticates the sender account. The second authentication type may be a type that determines whether the sender account has permission to send a message of the subtype, and authenticates the sender account if the sender account has permission to send a message of the subtype.

For example, the message transmission request may include information indicating the authentication type of the sender account (e.g., an authentication type flag of the sender account). The server may determine (e.g., check) the authentication type of the sender account based on the message transmission request. The server may compare the authentication information of the sender account and the registered authentication information if the determined authentication type is the first authentication type. The server may determine permission of the sender account if the determined authentication type is the second authentication type, and authenticate the sender account if the sender account has permission to send a message of the subtype.

In operation 640, the server may transmit the information and the message to the user terminal based on the successful authentication of the sender account. The server may transmit the message to the user terminal if the authentication of the sender account is successful, thereby guaranteeing the identity of the sender account.

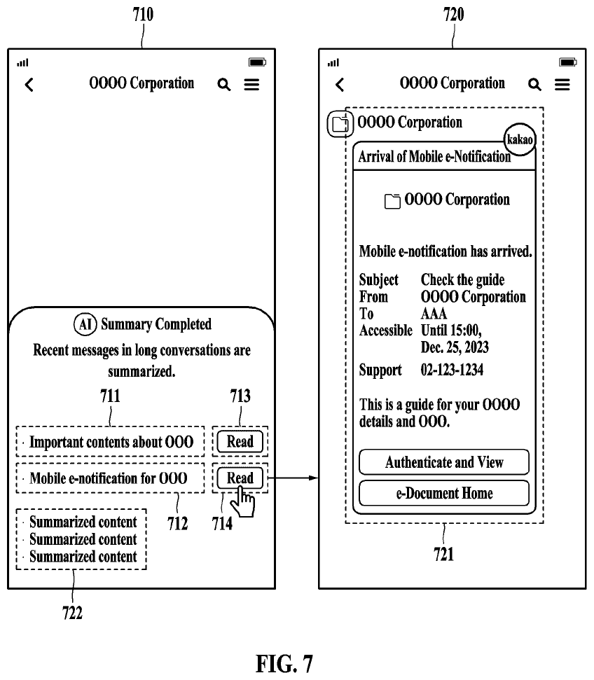

FIG. 7 is a diagram illustrating an example of an operation of providing a summary of a message by a message transmission system according to various embodiments.

According to an embodiment, a message transmission system (e.g., the message transmission system 100 of FIG. 1) may provide a message summary function. The message transmission system may generate and display a summarized text based on the subtype of a message.

A user terminal may transmit a summary request for a plurality of messages received in a chatroom to a server. The summary request may include a request to summarize messages transmitted and received through a chatroom specified by the summary request. The summary request may request summarizing messages unread based on a predetermined point in time among the messages transmitted and received in the chatroom. The predetermined point in time may be specified as the point in time just before the last entry into a chatroom page.

The server may receive the summary request for the plurality of messages in the chatroom from the user terminal. The server may generate a summarized text based on the type and/or subtype of the message.

The server may generate, for each information-type message based on the plurality of messages including one or more information-type messages, a first summarized text that summarizes a message of the corresponding information-type message. The server may generate first summarized texts that individually summarize the information-type messages. For example, if the messages include N information-type messages, the server may generate N first summarized texts individually corresponding to the N messages. A first summarized text may include a text that summarizes the corresponding information-type message.

The server may generate, based on the plurality of messages including one or more advertisement-type messages, a second summarized text that summarizes the one or more advertisement-type messages. The server may generate a second summarized text that summarizes one advertisement-type message or a plurality of advertisement-type messages. While each information-type message is individually used to generate a first summarized text, a plurality of advertisement-type messages may be used to generate one (e.g., one-sentence) second summarized text.

The server according to an embodiment may generate a summarized text (e.g., a first summarized text or a second summarized text) based on a machine learning model. The machine learning model may be a model that is generated and/or trained to provide output data corresponding to an output text that summarizes the substance of an input text by being applied to input data corresponding to the input text. According to an embodiment, the machine learning model may be implemented based on a neural network and/or a large language model (LLM).

If the messages include information-type messages, the server may obtain (e.g., generate or configure) input data corresponding to each information-type message, and generate a first summarized text corresponding to the message by applying the machine learning model to the obtained input data. If the messages include a plurality of advertisement-type messages, the server may obtain one input data corresponding to the plurality of advertisement-type messages, and generate a second summarized text corresponding to the plurality of advertisement-type messages by applying the machine learning model to the obtained input data.

The server may transmit, to the user terminal, information for displaying the first summarized texts individually corresponding to the one or more information-type messages and the second summarized text. The user terminal may receive, from the server based on the plurality of messages including the one or more information-type messages and the one or more advertisement-type messages, information for displaying the first summarized texts individually corresponding to the one or more information-type messages and the second summarized text that summarizes the one or more advertisement-type messages. The user terminal may display the first summarized texts and the second summarized text.

Referring to FIG. 7, the user terminal may request summarizing two information-type messages and ten advertisement-type messages. On a screen 710, the user terminal may display first summarized texts (e.g., a first summarized text 711 and a first summarized text 712) individually corresponding to the two information-type messages and a second summarized text 722. In FIG. 7, the ten advertisement-type messages may be divided into three topics and represented as three second summarized texts.

According to an embodiment, the message transmission system may provide a button for displaying an information-type message corresponding to a first summarized text along with the first summarized text. For example, the server may transmit, to the user terminal, information indicating the display of the button for displaying an information-type message corresponding to a first summarized text along with the first summarized text. The information indicating the display of the button for displaying an information-type message corresponding to a first summarized text may include information specifying a message corresponding to the first summarized text. The user terminal may receive, from the server, the information indicating the display of the button for displaying an information-type message corresponding to a first summarized text. The user terminal may display, at a position corresponding to each first summarized text, a button for detecting a user input that requests displaying an information-type message corresponding to the first summarized text.

Referring to FIG. 7, the first summarized text 711 may correspond to a first information-type message. The first summarized text 712 may correspond to a second information-type message 721. The user terminal may further display a button 713 for requesting the display of the first message, at a position corresponding to the first summarized text 711. Likewise, the user terminal may further display a button 714 for requesting the display of the second message, at a position corresponding to the first summarized text 712. When a user input that selects the button 714 is detected, the user terminal may display the second message 721 in a chatroom, as shown on a screen 720.

In various embodiments of the present disclosure, it is primarily described that the server individually generates summarized texts for information-type messages, but embodiments are not limited thereto. For example, the server may distinguish between messages whose subtype is an important information type and the remaining messages, individually generate summarized texts for the important-information-type messages, and generate a summarized text for the remaining messages (e.g., all at once).

FIG. 8 is a diagram illustrating an example of an operation of controlling the display of at least a portion of content by a user terminal according to various embodiments.

A user terminal (e.g., the user terminal 130 of FIG. 1) according to an embodiment may restrict the display of at least a portion of content provided in a chatroom based on the type of a message. The user terminal may determine a focused message while displaying the chatroom. A focused message may be a message expected to be primarily viewed by a user among messages in a chatroom. For example, the user terminal may determine the focused message among the messages based on the size of a displayed area.

The user terminal may control the display of at least a portion of the content based on the type of the focused message.

For example, the user terminal may determine (e.g., check) the type of a focused message among a plurality of messages transmitted through a chatroom. The user terminal may restrict the display of at least a portion of content provided in the chatroom based on a determination that the type of the focused message is an information type. The user terminal may display at least a portion of the content in a folded state based on a determination that the type of the focused message is an information type.

For example, the user terminal may display content provided in the chatroom based on a determination that the type of the focused message is an advertisement type. The user terminal may display at least a portion of the content in an unfolded state based on a determination that the type of the focused message is an advertisement type.

According to an embodiment, the user terminal may control the display of at least a portion of the content based on a change of the focused message. The user terminal may switch the focused message among the plurality of messages in the chatroom based on a user input (e.g., a swipe input) in the chatroom.

For example, when displaying a chatroom page, the user terminal may detect a user input that changes the focused message from a first message to a second message among the plurality of messages transmitted through the chatroom.

For example, the user terminal may display at least a portion of the content in response to the user input based on the type of the first message being an information type and the type of the second message being an advertisement type. The user terminal may change the display state of at least a portion of the content from a folded state to an unfolded state based on the type of the first message being an information type and the type of the second message being an advertisement type.

For example, the user terminal may restrict the display of at least a portion of the content in response to the user input based on the type of the first message being an advertisement type and the type of the second message being an information type. The user terminal may change the display state of at least a portion of the content from an unfolded state to a folded state based on the type of the first message being an advertisement type and the type of the second message being an information type.

Referring to FIG. 8, on a screen 810, the user terminal may display a chatroom page of a chatroom. The user terminal may determine (e.g., check) that the type of a focused message is an advertisement type and display at least a portion 811 of content provided in the chatroom without restriction (e.g., in an unfolded state) on the screen 810. The user terminal may detect a user input (e.g., a swipe input) that switches the focused message on the screen 810.

On a screen 820, the user terminal may determine (e.g., check) that the focused message has changed from an advertisement-type message to an information-type message. The user terminal may display a button 821 instead of at least a portion 811 of the content based on the type of the focused message being an information type. The user terminal may display at least a portion of the content in a folded state. The user terminal may detect a user input (e.g., a swipe input) that switches the focused message on the screen 820.

On a screen 830, the user terminal may determine (e.g., check) that the focused message has changed from an information-type message to an advertisement-type message. The user terminal may display at least a portion 831 of content provided in the chatroom without restriction (e.g., in an unfolded state), based on the type of the focused message being an advertisement type.

However, the user terminal according to various embodiments of the present disclosure is not limited to controlling the display of at least a portion of content based on the type of a focused message.

The user terminal according to an embodiment may control the display of at least a portion of content based on a user input (e.g., scroll input) that changes a focused message in a chatroom. The user input that changes the focused message may include a swipe input detected on the chatroom page. For example, the swipe input may have a swipe direction of either a first direction or a second direction opposite the first direction.

The first direction may be a direction to change the focused message in the direction of time sequence. For example, the first direction may include a direction from a lower point to an upper point of the chatroom page. In various embodiments of the present disclosure, the first direction may also be expressed as a forward direction. For example, in response to a user input in the first direction, the user terminal may change the focused message among the plurality of messages transmitted through the chatroom from a first message to a second message received after the first message.

The second direction may be a direction to change the focused message in the opposite direction of time sequence. For example, the second direction may be a direction from an upper point to a lower point of the chatroom page. In various embodiments of the present disclosure, the second direction may also be expressed as a backward direction. For example, in response to a user input in the second direction, the user terminal may change the focused message among the plurality of messages transmitted through the chatroom from a first message to a second message received before the first message.

The user terminal according to an embodiment, when displaying a chatroom page, may detect a user input that changes the focused message from a first message to a second message among the plurality of messages transmitted through the chatroom. The user terminal may restrict the display of at least a portion of the content in response to a swipe input detected in the chatroom. The user terminal may restrict the display of at least a portion of the content based on the focused message changing from the first message to the second message.

According to an embodiment, the user terminal may restrict the display of at least a portion of the content in response to a swipe input detected on the chatroom page. For example, the user terminal may restrict the display of at least a portion of the content in response to the swipe input, independently of the swipe direction (e.g., independently of whether the swipe direction is the first direction or the second direction).

According to an embodiment, the user terminal may restrict the display of at least a portion of the content in response to a swipe input in a predetermined direction (e.g., the second direction or the backward direction). The user terminal may display at least a portion of the content in response to a swipe input in a direction (e.g., the first direction or the forward direction) other than the predetermined direction. For example, the user terminal may restrict the display of at least a portion of the content in response to a user input, based on the second message being a message transmitted before the first message. For example, the user terminal may display at least a portion of the content in response to a user input, based on the second message being a message transmitted after the first message.

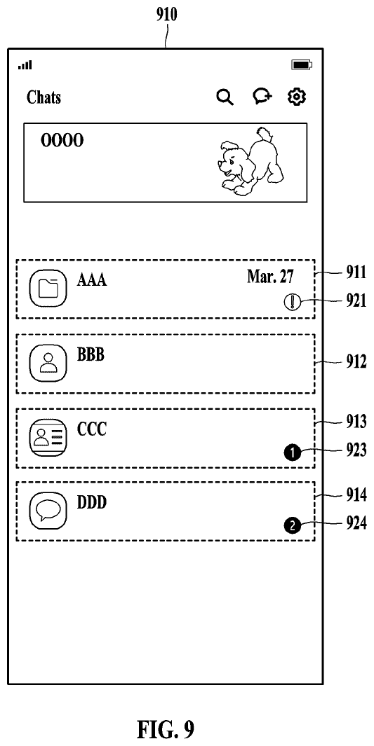

FIG. 9 illustrates an example of a chatroom list screen of a user terminal according to various embodiments.

A user terminal (e.g., the user terminal 130 of FIG. 1) according to an embodiment may display an area corresponding to each chatroom on a chatroom list screen 910. The user terminal may provide the chatroom list screen 910 including areas corresponding to chatrooms in which a user account participates. The chatroom list screen 910 may include an area corresponding to each chatroom. If there is an unread message among messages received through each chatroom, the user terminal may display a graphical object (e.g., a badge object) indicating the presence of an unread message in an area corresponding to the chatroom. For example, the graphical object may include a graphical representation that represents the number of unread messages.

Referring to FIG. 9, the user terminal according to an embodiment may display the chatroom list screen 910. The chatroom list screen 910 may include an area 911 corresponding to a first chatroom, an area 912 corresponding to a second chatroom, an area 913 corresponding to a third chatroom, and an area 914 corresponding to a fourth chatroom. In FIG. 9, there may be unread messages among the messages received through the first chatroom, the third chatroom, and the fourth chatroom. The user terminal may display a graphical object 921 in the area 911 corresponding to the first chatroom, a graphical object 923 in the area 913 corresponding to the third chatroom, and a graphical object 924 in the area 914 corresponding to the fourth chatroom. The graphical object 923 may include a graphical representation indicating that the number of unread messages is “1,” and the graphical object 924 may include a graphical representation indicating that the number of unread messages is “2.”

According to an embodiment, the user terminal may determine and/or display a graphical object based on the type and/or subtype of an unread message among the messages received through a chatroom. For example, the user terminal may display the graphical object as one of a first graphical representation or a second graphical representation. The first graphical representation may correspond to an information type, and the second graphical representation may correspond to a type (e.g., an advertisement type) other than the information type. If it is determined that the type of an unread message received through a chatroom is an information type, the user terminal may display a graphical object as the first graphical representation in an area corresponding to the chatroom on the chatroom list screen 910. If it is determined that the type of an unread message received through a chatroom is a type (e.g., an advertisement type) other than the information type, the user terminal may display a graphical object as the second graphical representation in an area corresponding to the chatroom on the chatroom list screen 910.

In FIG. 9, for example, the user terminal may display the graphical object 921 as the first graphical representation based on a determination that the type of an unread message received through the first chatroom is an information type. The user terminal may display the graphical object 923 (or the graphical object 924) as the second graphical representation based on a determination that the type of an unread message received through the third chatroom or the fourth chatroom is an advertisement type.

According to an embodiment, if there are a plurality of unread messages among messages received through a chatroom, the user terminal may determine a graphical representation of a graphical object based on the last message. For example, if it is determined that the type of the last message, among the messages received through the chatroom, is an information type, the user terminal may display a graphical object as the first graphical representation in an area corresponding to the chatroom on the chatroom list screen 910. For example, if it is determined that the type of the last message, among the messages received through the chatroom, is a type (e.g., an advertisement type) other than the information type, the user terminal may display a graphical object as the second graphical representation in an area corresponding to the chatroom on the chatroom list screen 910.

According to an embodiment, if there are a plurality of unread messages among the messages received through a chatroom and the unread messages include one or more information-type messages, the user terminal may display a graphical object as the first graphical representation. For example, if it is determined that the type of at least one unread message is an information type, the user terminal may display a graphical object as the first graphical representation in an area corresponding to the chatroom on the chatroom list screen 910. If it is determined that the types of all unread messages received through a chatroom are types (e.g., an advertisement type) other than the information type, the user terminal may display a graphical object as the second graphical representation in an area corresponding to the chatroom on the chatroom list screen 910.

In various embodiments of the present disclosure, it is primarily described that the user terminal determines and/or displays a graphical representation of a graphical object by distinguishing between a message of an information type and a message of a type (e.g., an advertisement type) other than the information type, but embodiments are not limited thereto.

For example, if it is determined that the subtype of an unread message, among the messages received through a chatroom, is an important information type, the user terminal may display a graphical object as the first graphical representation. If it is determined that the subtype of an unread message, among the messages received through a chatroom, is a subtype (e.g., a general information type) other than the important information type, the user terminal may display a graphical object as the second graphical representation.

The examples described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is singular; however, one of ordinary skill in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof.

A number of example embodiments have been described above. Nevertheless, it should be understood that various modifications may be made to these example embodiments. For example, suitable results may be achieved if the described techniques are performed in a different order, and/or if components in a described system, structure, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of displaying a message, performed by a user terminal, the method comprising:
receiving, from a server, information about a message through a chatroom of a user account and a sender account;
checking a type of the message using the information about the message, wherein the type of the message is one of a plurality of types comprising an advertisement type and an information type; and
displaying the message through a chatroom page corresponding to the chatroom and restricting display of at least a portion of content provided in the chatroom, based on the type of the message being an information type.

2. The method of claim 1, wherein the displaying of the message and restricting of the display of at least a portion of the content comprises restricting display of advertising content provided in the chatroom or display of a button to enter a service page provided by the sender account in the chatroom.

3. The method of claim 1, wherein:
the checking of the type of the message comprises checking a subtype of the message based on the type of the message being an information type, wherein the subtype of the message is selected from a plurality of subtypes including at least a general information type and an important information type, and
the displaying of the message and restricting of the display of at least a portion of the content comprises displaying, based on the subtype of the message being an important information type, a graphical representation that represents the important information type along with the message.

4. The method of claim 1, further comprising:
transmitting, to the server, a summary request for a plurality of messages received in the chatroom;
receiving, from the server based on the plurality of messages comprising one or more information-type messages and one or more advertisement-type message, information for displaying first summarized texts individually corresponding to the one or more information-type messages and a second summarized text that summarizes the one or more advertisement-type message; and
displaying the first summarized texts and the second summarized text.

5. The method of claim 1, wherein:
the checking of the type of the message comprises checking the type of a last message among messages transmitted through the chatroom, and
the displaying of the message and restricting of the display of at least a portion of the content comprises restricting display of at least a portion of the content based on the type of the last message being an information type.

6. The method of claim 1, wherein:
the checking of the type of the message comprises checking types of a plurality of unread messages transmitted through the chatroom,
the displaying of the message and restricting of the display of at least a portion of the content comprises restricting display of at least a portion of the content provided in the chatroom, based on a type of at least one of the plurality of unread messages being an information type, and
the method comprises displaying the content provided in the chatroom, based on types of all of the plurality of unread messages being an advertisement type.

7. The method of claim 1, wherein:
the checking of the type of the message comprises checking a type of a focused message among a plurality of messages transmitted through the chatroom, and
the displaying of the message and restricting of the display of at least a portion of the content comprises restricting display of at least a portion of the content provided in the chatroom, based on the type of the focused message being an information type.

8. The method of claim 1, further comprising:
detecting a user input that changes a focused message among a plurality of messages transmitted through the chatroom from a first message to a second message, when displaying the chatroom page;
displaying at least a portion of the content based on to the user input, based on a type of the first message being an information type and a type of the second message being an advertisement type; and
restricting at least a portion of the content based on to the user input, based on the type of the first message being an advertisement type and the type of the second message being an information type.

9. The method of claim 7, further comprising:
detecting a user input that changes a focused message among a plurality of messages transmitted through the chatroom from a first message to a second message, when displaying the chatroom page; and
restricting display of at least a portion of the content based on the user input, based on the second message being a message transmitted before the first message.

10. A method of providing a message, performed by a server, the method comprising:
receiving, from a sender terminal of a sender account, a message transmission request that requests delivery of a message to a user account through a chatroom;
determining a type of the message to be one of a plurality of types comprising an advertisement type and an information type, based on the message transmission request; and
transmitting information indicating restriction on display of at least a portion of content provided in the chatroom along with the message to a user terminal of the user account, based on a determination that the type of the message is an information type.

11. The method of claim 10, wherein the transmitting of the information along with the message comprises transmitting information indicating restriction on display of advertising content provided in the chatroom or display of a button to enter a service page provided by the sender account in the chatroom to the user terminal.

12. The method of claim 10, wherein:
the determining of the type of the message comprises determining a subtype of the message to be one of a plurality of subtypes comprising a general information type and an important information type, based on a determination that the type of the message is an information type, and
the transmitting of the information comprises transmitting, to the user terminal based on a determination that the subtype of the message is an important information type, information indicating display of a graphical representation that represents the important information type along with the message.

13. The method of claim 10, wherein:
the receiving of the message transmission request comprises receiving, from the sender terminal, the message transmission request comprising authentication information of the sender account, and
the transmitting of the information comprises:
authenticating the sender account by comparing the authentication information of the sender account with registered authentication information that is registered for the sender account, based on a determination that the subtype of the message is an important information type; and
transmitting the information and the message to the user terminal, based on successful authentication of the sender account.

14. The method of claim 13, wherein the authenticating of the sender account comprises:
determining whether the sender account has permission to transmit an important-information-type message, based on a determination that the subtype of the message is an important information type; and
authenticating the sender account, based on a determination that the sender account has permission to transmit an important-information-type message.

15. The method of claim 10, further comprising:
receiving, from the user terminal, a summary request for a plurality of messages in the chatroom;
generating, for each information-type message based on the plurality of messages comprising one or more information-type messages, a first summarized text that summarizes the information-type message;
generating, based on the plurality of messages comprising one or more advertisement-type messages, a second summarized text that summarizes the one or more advertisement-type messages; and
transmitting, to the user terminal, information for displaying first summarized texts individually corresponding to the one or more information-type messages and the second summarized text.

16. A non-transitory computer-readable storage medium storing instructions that, when executed by one or more processors, cause the one or more processors to perform the method of claim 1.

17. A user terminal comprising:
one or more processors configured to:
receive, from a server, information about a message through a chatroom of a user account and a sender account,
check a type of the message using the information about the message, wherein the type of the message is one of a plurality of types comprising an advertisement type and an information type, and
display the message through a chatroom page corresponding to the chatroom and restrict display of at least a portion of content provided in the chatroom, based on the type of the message being an information type.

18. The method of claim 1, wherein restricting the display of at least a portion of content comprises:
displaying a button to display at least a portion of the content instead of the content itself, wherein the content is displayed in a folded state.

19. The method of claim 18, further comprising:
displaying the content in an unfolded state based on user input selecting the button.

20. The method of claim 1, wherein checking the type of the message comprises extracting a type flag from metadata associated with the message and mapping the flag to a predefined message type.
